(19) United States
(12) Patent Application Publication
(10) Pub. No.: US 2024/0283741 A1
(43) Pub. Date: Aug. 22, 2024

(54) SEGMENTED LOOKUP TABLE FOR LARGE-SCALE ROUTING

(71) Applicant: MELLANOX TECHNOLOGIES, LTD., Yokneam (IL)

(72) Inventors: Lior Hodaya Bezen, Tel-Aviv (IL); Roee Levy Leshem, Tel-Aviv (IL); Lion Levi, Yavne (IL); Michael Goldman, Petach-Tiqwa (IL); Itamar Rabenstein, Petach-Tiqwa (IL); Eyal Srebro, Kfar Yehoshua (IL); Uriel Vanunu, Tel Aviv (IL); Alex Netes, Rehovot (IL); Yakir Yosefi, Kfar Saba (IL)

(21) Appl. No.: 18/112,823

(22) Filed: Feb. 22, 2023

(51) Int. Cl. H04L 45/745; H04L 45/00

(52) U.S. Cl. CPC H04L 45/745; H04L 45/566

(57) ABSTRACT

A switch, communication system, and method are provided. In one example, a communication system is described that includes a plurality of communication nodes and a switch that interconnects and facilitates a transmission of packets between the plurality of communication nodes. The communication system may be configured such that the packets are transmitted between the plurality of communication nodes using a segmented forwarding table.

### FIELD OF THE DISCLOSURE

The present disclosure is generally directed toward networking and, in particular, toward networking devices, switches, and methods of operating the same.

### BACKGROUND

Switches and similar network devices represent a core component of many communication, security, and computing networks. Switches are often used to connect multiple devices, device types, networks, and network types.

An InfiniBand (IB) network is composed of one or more subnets connected by InfiniBand routers. Each subnet consists of processing nodes and input/output (I/O) devices connected by InfiniBand Switches. Each subnet is managed by a subnet manager (SM). To realize a path in an IB network, an address, known as a local identifier (LID), is assigned to the destination of the path and is used in the forwarding tables of intermediate switches to direct the traffic following the path. In other words, a LID is assigned to a destination and is used in intermediate switches to route data to the destination.

NVLink is a wire-based serial multi-lane communication link. A device may have multiple NVLinks, and devices may use mesh networking to communicate instead of a central hub.

### BRIEF SUMMARY

Network topology describes the arrangement of the network elements (links, nodes, etc.) of a communication network. Network topology is the structure of a network and may be depicted physically or logically. Physical topology is the placement of the various components of a network (e.g., device location and cable installation), while logical topology illustrates how data flows within a network. Logically, a network may be separated into separate parallel planes, which allows support of larger scale networks at low latency. The number of planes may vary and depends on the topology structure of a network and the number of connected devices.

Throughout the instant description, a switch integrated circuit (IC) should generally be understood to comprise switching hardware, such as an application specific integrated circuit (ASIC) that has switching capabilities. Multiplane network devices and non-multiplane network devices used in multiplane networks described herein may each include a single switch IC or multiple switch ICs.

Inventive concepts relate to network devices for a multiplane network (also called a planarized network or planarization or the like). A multiplane network may be implemented by dividing the switching fabric of a traditional communication network into multiple planes. For example, a related art, non-multiplane network device for HPC systems may include a single high-bandwidth switch IC that is managed on a per-switch IC basis along with other high-bandwidth switches in the same network device or in other network devices of the switching fabric.

A multiplane network device according to inventive concepts, however, is a network device having multiple smaller-bandwidth switch ICs that, when taken collectively, have an aggregated bandwidth equal to the single high-bandwidth switch IC of the related art. In addition, the multiple smaller bandwidth switch ICs of a multiplane network device may not be visible to the user (e.g., the multiple switch ICs are not exposed to an application programming interface (API) that enables user interaction with the network so that applications can use the network without being aware of the planes). Stated another way, the system is constructed such that applications perceive the multiple smaller bandwidth switch ICs of a multiplane network device as a single, larger bandwidth switch IC.

In the NVLink fabric, the number of local identifiers (LIDs) may exceed the number of forwarding entries available in the switch pipe. Therefore, in order to support a large number of LIDs, a switch shares its forwarding table between multiple ports in the switch, and each port belongs to a plane of multiple planes, which results in a larger shared table that is able to utilize more LIDs, but with a cost of reduced lookup speed.

In a planarized network, a forwarding table may be configured by separating addresses (e.g., LIDs) into different ranges and assigning traffic (e.g., based on packet type) to certain address ranges. For example, high bandwidth traffic may be assigned to a first range of addresses, and low bandwidth traffic (e.g., switch management traffic) may be assigned to a second range of addresses. Furthermore, the first range of addresses may be assigned to a specific plane, and the second range of addresses is shared between multiple planes and/or multiple ports.

For example, a switch forwarding table may split the entire LIDs range into two sections: (1) a per port section (e.g., not shared); and (2) a shared section. Since the per port section prevents collisions (e.g., several ports accessing the same database at the same time), the present disclosure allows for faster lookup and it can be used for high priority/high bandwidth data. Although the shared section may have a slower lookup, the shared section can be used for low priority data (e.g., switch management data) that is not impacted by the slower lookup).

Embodiments of the present disclosure aim to solve the above-noted shortcomings and other issues by implementing an improved routing approach. The routing approach depicted and described herein may be applied to a switch, a router, or any other suitable type of networking device known or yet to be developed. As will be described in further detail herein, a switch that implements the routing approaches described herein may correspond to an optical routing switch (e.g., an Optical Circuit Switch (OCS)), an electrical switch, a combined electro-optical switch, or the like.

The routing approach provided herein may utilize a segmented forwarding table to take advantage of shared tables (more forwarding entries), without sacrificing lookup speed for high bandwidth traffic. The goal with a segmented forwarding table is to enable intelligent routing decisions while minimizing the time it takes for high bandwidth packets to reach their destination communication node.

The routing approach described herein decreases the lookup time for high bandwidth traffic. For example, each pipe includes its own cookie jar for obtaining cookies (e.g., addresses) and, instead of waiting in line to get a cookie from a shared cookie jar, the pipe can get the cookie from its own cookie jar (which is not shared).

In an illustrative example, a switch is disclosed that includes: a plurality of ports, each port in the plurality of ports being configured to connect with a communication node; switching hardware configured to selectively interconnect the plurality of ports, thereby enabling communications between the plurality of ports; and a switching engine that controls a transmission of packets across the switching hardware by segmenting a forwarding table into one or more address ranges.

In another example, a communication system is disclosed that includes: a plurality of communication nodes; and a switch that interconnects and facilitates a transmission of packets between the plurality of communication nodes, where the packets are transmitted between the plurality of communication nodes by segmenting a forwarding table into one or more address ranges.

In yet another example, a method of routing packets is disclosed that includes: connecting a plurality of communication nodes to a switch; selectively enabling the plurality of communication nodes to communicate via the switch; defining a forwarding table, wherein the forwarding table is segmented into a first range of addresses that is accessible by a specific port of the switch, and a second range of addresses that is shared by a plurality of ports of the switch; and controlling a transmission of packets between the communication nodes based on the segmented forwarding table.

Any of the above example aspects include wherein the forwarding table is segmented into a first range of addresses accessible by a specific port, and a second range of addresses shared by a plurality of ports.

Any of the above example aspects include wherein the first range of addresses is used for high bandwidth traffic, and wherein the second range of addresses is used for network management traffic and/or low bandwidth traffic.

Any of the above example aspects include wherein the high bandwidth traffic is identified based on packet header information.

Any of the above example aspects include wherein the first range of addresses is continuous.

Any of the above example aspects include wherein the second range of addresses is continuous.

Any of the above example aspects include wherein the first range of addresses comprises addresses from a local forwarding table, and the second range of addresses comprises addresses from a plurality of shared forwarding tables.

Any of the above example aspects include wherein the switching hardware comprises optical communication components, and wherein the packets are transmitted across the switching hardware using an optical signal.

Any of the above example aspects include wherein the switching hardware comprises electrical communication components, and wherein the packets are transmitted across the switching hardware using an electrical signal.

Any of the above example aspects include wherein the first range of addresses comprises addresses in a local forwarding table.

Any of the above example aspects include wherein the second range of addresses comprises addresses from a plurality of shared forwarding tables.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a communication system in accordance with at least some embodiments of the present disclosure;

FIG. 2 is a block diagram depicting an illustrative configuration of a switch in accordance with at least some embodiments of the present disclosure;

FIG. 3 illustrates an example of the segmentation of LIDs into ranges in accordance with at least some embodiments of the present disclosure;

FIG. 4 illustrates an example segmented forwarding table in accordance with embodiments of the present disclosure; and

FIG. 5 is a flow diagram depicting a method of routing packets in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

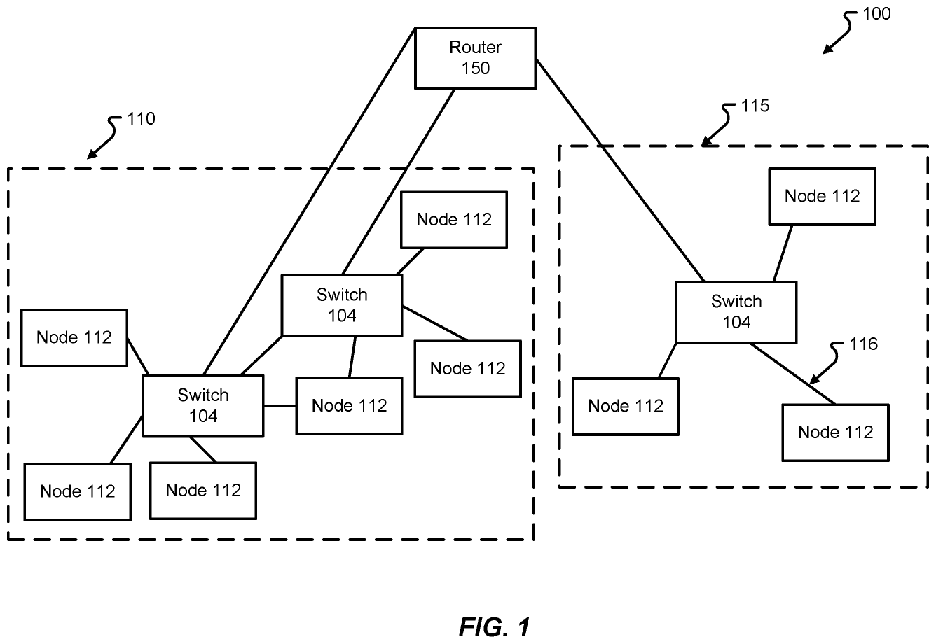

Referring now to FIGS. 1-5, various systems and methods for routing packets between communication nodes will be described. The concepts of packet routing depicted and described herein can be applied to the routing of information from one computing device to another. The term packet as used herein should be construed to mean any suitable discrete amount of digitized information. The information being routed may be in the form of a single packet or multiple packets without departing from the scope of the present disclosure. Furthermore, certain embodiments will be described in connection with a system that is configured to make centralized routing decisions whereas other embodiments will be described in connection with a system that is configured to make distributed and possibly uncoordinated routing decisions. It should be appreciated that the features and functions of a centralized architecture may be applied or used in a distributed architecture or vice versa.

FIG. 1 illustrates a communication system 100 that includes a router 150 connecting subnets 110 and 115. The subnets 110 and 115 include nodes 112 (e.g., personal computers (PCs), servers, storage appliances, peripheral devices, etc.) and switches 104. Each node 112 may be configured with a host channel adapter (HCA). The subnets 110 and 115 may also include subnet managers (SM) not shown. All devices in a subnet (e.g., the subnets 110 and 115) have a local identifier (LID), a 16-bit address assigned by the subnet manager. All packets sent within a subnet use the LID as the destination address for forwarding and switching packets at the link level. The LIDs allow for up to 48,000 end nodes within a single subnet. When a subnet is reconfigured, new LIDs are assigned to the various endpoints within the subnet.

The number of LIDs may exceed the number of forwarding entries available in the switch pipe. Therefore, in order to support a large number of LIDs, a switch shares its forwarding table between multiple pipes, which creates a larger shared table, but with a cost of reduced destination pipe lookup speed.

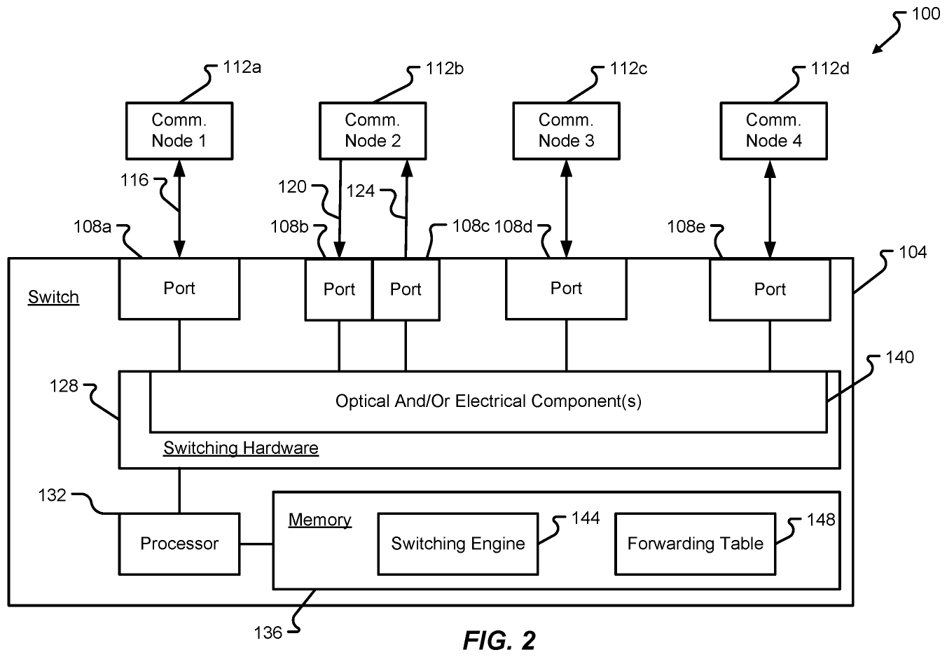

Referring to FIG. 2, a first possible configuration of a communication system 100 will be described in accordance with at least some embodiments of the present disclosure. It should be appreciated that the components described with reference to FIG. 2 may or may not also be used in a communication system 100 as shown in FIG. 1.

In the configuration of FIG. 2, a communication system 100 is shown to include a switch 104 connecting one or more communication nodes 112 via a number of communication ports 108. The illustrated switch 104 is shown to be connected with four communication nodes 112a-d via a plurality of communication ports 108a-e. The illustration of four communication nodes 112a-d is for ease of discussion and should not be construed as limiting embodiments of the present disclosure. Specifically, a switch 104 may be configured to connect any suitable number of communication nodes 112, and the switch 104 may include a number of ports 108 to facilitate such connections. Even more specifically, a switch 104 may be configured to connect a greater or lesser number of communication nodes 112 than are shown in FIG. 2. Moreover, embodiments of the present disclosure contemplate that not all ports 108 of a switch 104 need to be connected with a communication node 112. For instance, one or more ports 108 of a switch 104 may be left unconnected (e.g., open) and may not have any particular networking cable 116 plugged into the port 108.

The communication nodes 112a-d may be the same type of devices or different types of devices. As a non-limiting example, some or all of the communication nodes 112a-d may correspond to a Top-of-Rack (TOR) switch. Alternatively or additionally, one or more of the communication nodes 112a-d may correspond to a device other than a TOR switch. The communication nodes 112a-d do not necessarily need to communicate using the same communication protocol because the switch 104 may include components to facilitate protocol conversion and/or a communication node 112 may be connected to the switch 104 via a pluggable network adapter.

While the communication nodes 112a-d may correspond to a TOR switch, one or more of the communication nodes 112a-d may be considered host devices, servers, network appliances, data storage devices, or combinations thereof. A communication node 112, in some embodiments, may correspond to one or more of a personal computer (PC), a laptop, a tablet, a smartphone, a server, a collection of servers, or the like. It should be appreciated that a communication node 112 may be referred to as a host, which may include a network host, an Ethernet host, an InfiniBand (IB) host, etc. As another specific but non-limiting example, one or more of the communication nodes 112 may correspond to a server offering information resources, services and/or applications to user devices, client devices, or other hosts in the communication system 100. It should be appreciated that the communication nodes 112 may be assigned at least one network address (e.g., an IP address) and the format of the network address assigned thereto may depend upon the nature of the network to which the communication node 112 is connected.

A communication node 112 (e.g., the second communication node 112b) may alternatively, or additionally, be connected with the switch 104 via multiple ports 108 (e.g., the second port 108b and third port 108c). In such a configuration, one of the ports 108 may be used to carry packets from the switch 104 to the communication node 112 whereas the other of the ports 108 may be used to carry packets from the communication node 112 to the switch 104. As an example, the second port 108b is shown to receive packets from the second communication node 112b via a data uplink 120 whereas the third port 108c is shown to carry packets from the switch 104 to the second communication node 112b via a data downlink 124. In this configuration, separate networking cables may be used for the data uplink 120 and the data downlink 124.

The switch 104 may correspond to an optical switch and/or electrical switch. In some embodiments, the switch 104 may include switching hardware 128 that is configurable to selectively interconnect the plurality of ports 108a-e, thereby enabling communications between the plurality of ports 108a-e, which enables communications between the communication nodes 112a-d. In some embodiments, the switching hardware 128 may be configured to selectively enable the plurality of communication nodes 112a-d to communicate in pairs based on a particular configuration of the switching hardware 128. Specifically, the switching hardware 128 may include optical and/or electrical component(s) 140 that are switchable between different matching configurations. In some embodiments, the optical and/or electrical components 140 may be limited in the number of matching configurations it can accommodate, meaning that a port 108 may not necessarily be connected with or matched with every other port 108 at a particular instance in time.

In some embodiments, the switch 104 may correspond to an optical circuit switch, which means that the optical and/or electrical components 140 may include a number of optical and/or opto-electronic components that switch optical signals from one channel to another. The optical and/or electrical components 140 may be configured to provide an optical switching fabric, in some embodiments. As an example, the optical and/or electrical component(s) 140 may be configured to operate by mechanically shifting or moving an optical fiber to drive one or more alternative fibers. Alternatively or additionally, the optical and/or electrical component(s) 140 may include components that facilitate switching between different port matchings by imparting electro-optic effects, magneto-optic effects, or the like. For instance, micromirrors, piezoelectric beam steering mechanisms, liquid crystals, filters, and the like may be provided in the optical and/or electrical components 140 to facilitate switching between different matching configurations of optical channels.

In some embodiments, the switch 104 may correspond to an electrical switch, which means that the optical and/or electrical components 140 may include a number of electrical components or traditional electronic circuitry that is configured to manage packet flows and packet transmissions. Accordingly, the optical and/or electrical components 140 may alternatively or additionally include one or more integrated circuit (IC) chips, microprocessors, circuit boards, data processing units (DPUs), simple analog circuit components (e.g., resistors, capacitors, inductors, etc.), digital circuit components (e.g., transistors, logic gates, etc.), memory devices, field programmable gate arrays (FPGAs), application specific integrated circuits (ASICs), combinations thereof, and the like.

The switch 104 may correspond to an optical switch and/or electrical switch. In some embodiments, the switch 104 may include switching hardware 128 that is configurable to selectively interconnect the plurality of ports 108a-e, thereby enabling communications between the plurality of ports 108a-e, which enables communications between the communication nodes 112a-d.

In some embodiments, the switch 104 may include a processor 132 that executes the switching engine 144, which is stored in memory 136. The forwarding table 148 may also be stored in memory 136 and may be referenced by the processor 132 when executing the switching engine 144.

Although not depicted, a communication node 112 may include a processor 132 and memory 136 as shown in the switch 104 of FIG. 2. The communication nodes 112a-d are not shown with a processor 132 and memory 136 for ease of discussion and clarity of the drawings, but this should not be construed as limiting embodiments of the present disclosure.

The processor 132 (whether provided in the switch 104 or a communication node 112) may be configured to execute the instructions (e.g., the switching engine 144) stored in memory 136. As some non-limiting examples, the processor 132 may correspond to a microprocessor, an IC chip, a central processing unit (CPU), a graphics processing unit (GPU), a DPU, or the like. The memory 136 may correspond to any appropriate type of memory device or collection of memory devices configured to store instructions. Non-limiting examples of suitable memory devices that may be used for memory 136 include flash memory, random access memory (RAM), read only memory (ROM), variants thereof, combinations thereof, or the like. In some embodiments, the memory 136 and processor 132 may be integrated into a common device (e.g., a microprocessor may include integrated memory).

The hardware forwarding table for a switch (e.g., switch 104) may be divided into at least two sections: (1) Local plane addresses range (one range for each plane); and (2) All addresses range includes the full LID space (e.g., all planes). Hosts may be connected to more than one switch via different ports. For example, a host with four ports may be connected to four different switches, such that the host may access four different planes (e.g., one plane per switch). In embodiments, the host may also access multiple planes via a single switch configured with multiple planes. In a multi-plane network, hosts cannot cross planes (in contrast to management nodes, which can cross planes). Therefore, hosts need to have the ability to send high bandwidth messages only on their local planes, while the management nodes need to see the entire LID space for low bandwidth messages. In other words, hosts use the local plane addresses to send messages on their local plane. The all addresses range is shared between several control pipes unicast tables. The shared range is divided equally between the pipes, such that each pipe holds a same-size portion of the shared range. In embodiments, the forwarding table may be divided into additional sections (e.g., a global range, etc.).

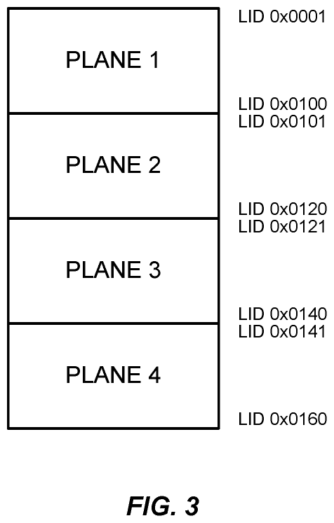

Hosts may be connected to multiple switches via different ports. For example, each host may have four ports, and each port may be connected to a different switch, such that there are four different planes. The hosts cannot cross planes while management nodes can cross planes. The hosts need to have the ability to send high bandwidth messages only on their local planes, while the managements nodes need to see the entire LID space for low bandwidth messages (e.g., global). From the SM point of view, the meaning of this division is that the LID assignment per GPU port will not be continuous for ports that are not in the same plane. Furthermore, the ranges do not overlap with each other; each range is assigned with a continuous LID space; the ranges assigned to the planes are continuous (meaning that the plane i+1 range must come right after the plane i range); and the global and ALID ranges can come before or after the ranges for the different planes, but not in between planes (see FIG. 3).

FIG. 3 illustrates how the LID space may be segmented among the different sections. LIDs 0x0001-0x0100 are for a first plane; LIDs 0x0101-0x0120 are for the second plane; LIDs 0x0121-0x0140 are for a third plane; and LIDs 0x0141-0x0160 are for a fourth plane. The range between the first and second plane is continuous. Although, only four planes are illustrated, it is understood that the present disclosure supports any number of different planes.

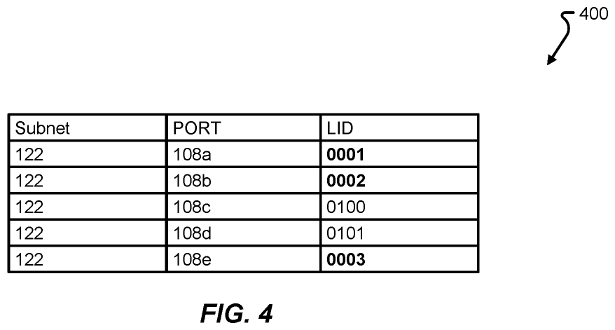

With reference now to FIG. 4, an example segmented forwarding table is illustrated. The segmented forwarding table 400 includes columns subnet, port, and LID. The subnet column indicates the subnet the device is on. The port column indicates which egress port should be used. The LID column indicates the LID for the port.

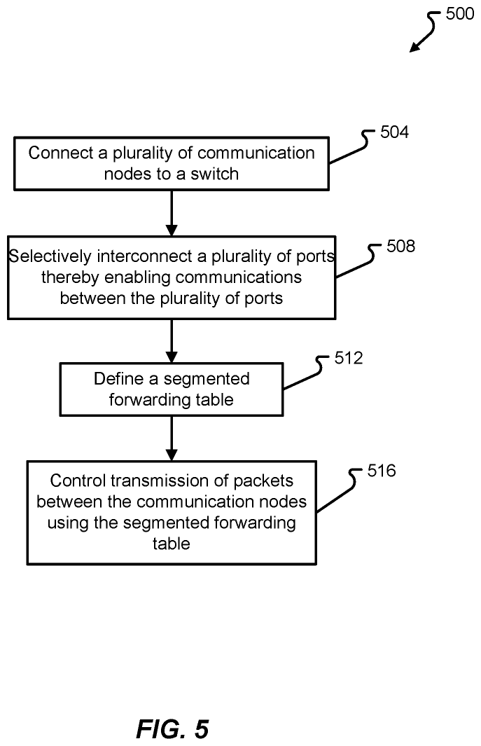

Referring now to FIG. 5, an illustrative method 500 will be described in accordance with at least some embodiments of the present disclosure. The method 500 may be performed in a switch 104 by a processor 132 implementing a switching engine 144. Alternatively or additionally, the method 500 may be performed in one or multiple communication nodes 112 by a processor 132 implementing a switching engine 144.

The order of operations depicted in FIG. 5 should not be construed as limiting embodiments of the present disclosure. For instance, certain steps may be performed in a different order without departing from the scope of the present disclosure. Furthermore, some steps may be performed in parallel (e.g., simultaneously) with one another.

The method 500 begins by connecting a plurality of communication nodes 112 to a switch 104 (step 504). The plurality of communication nodes 112 may be connected to the switch 104 via one or more ports 108 of the switch 104. In some embodiments, each communication node 112 may be connected to one port 108 of the switch 104 via a data uplink 120 and another port 108 of the switch 104 via a data downlink 124. In some embodiments, networking cables and/or pluggable network adapters may be used to connect the communication nodes 112 to one or more ports 108 of the switch 104. As can be appreciated, the nature of the switch 104 (e.g., whether the switch 104 is an optical switch or an electrical switch) may determine the type of networking cable that is used to connect the communication nodes 112 to the switch 104.

The method 500 may continue by selectively interconnecting a plurality of ports, thereby enabling communications between the plurality of ports (step 508).

The method 500 may further include defining a segmented forwarding table (e.g., segmented forwarding table 148) (step 512). In some embodiments, the segmented forwarding table may be maintained in memory at the switch 104.

The method 500 may further include controlling transmission of packets between the communication nodes using the segmented forwarding table (step 516). A column may include a LID for routing from a source communication node 112 to a destination communication node 112.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. A switch, comprising:
a plurality of ports, each port in the plurality of ports being connectable with a communication node;
switching hardware to selectively interconnect the plurality of ports, thereby enabling communications between the plurality of ports; and
a switching engine to control a transmission of packets across the switching hardware by segmenting a forwarding table into one or more address ranges, wherein the forwarding table is segmented into a first range of addresses accessible by a specific plane, and a second range of addresses shared between multiple planes.

2. The switch of claim 1, wherein the first range of addresses is accessible by a specific port, and the second range of addresses is shared by a plurality of ports.

3. The switch of claim 2, wherein the first range of addresses is used for high bandwidth traffic, and wherein the second range of addresses is used for network management traffic.

4. The switch of claim 3, wherein the high bandwidth traffic is identified based on packet header information.

5. The switch of claim 2, wherein the first range of addresses is continuous.

6. The switch of claim 2, wherein the second range of addresses is continuous.

7. The switch of claim 2, wherein the first range of addresses comprises addresses from a local forwarding table, and the second range of addresses comprises addresses from a plurality of shared forwarding tables.

8. The switch of claim 1, wherein the switching hardware comprises optical communication components, and wherein the packets are transmitted across the switching hardware using an optical signal.

9. The switch of claim 1, wherein the switching hardware comprises electrical communication components, and wherein the packets are transmitted across the switching hardware using an electrical signal.

10. A communication system, comprising:
switching hardware that interconnects and facilitates a transmission of packets between a plurality of communication nodes, wherein the switching hardware facilitates the transmission of the packets by segmenting a forwarding table into one or more address ranges, wherein a first range of addresses is accessible by a specific plane, and a second range of addresses is shared between multiple planes.

11. The communication system of claim 10, wherein the first range of addresses is accessible by a specific port, and the second range of addresses is shared by a plurality of ports.

12. The communication system of claim 11, wherein the first range of addresses is used for high bandwidth traffic.

13. The communication system of claim 11, wherein the second range of addresses is used for network management traffic.

14. The communication system of claim 11, wherein the first range of addresses and the second range of addresses are continuous.

15. The communication system of claim 12, wherein the high bandwidth traffic is identified based on packet header information.

16. The communication system of claim 10, wherein the switching hardware comprises optical communication components, and wherein the packets are transmitted across the switching hardware using an optical signal.

17. A method of routing packets, comprising:
connecting a plurality of communication nodes to a switch;
selectively enabling the plurality of communication nodes to communicate via the switch;
defining a forwarding table, wherein the forwarding table is segmented into a first range of addresses that is accessible by a specific plane, and a second range of addresses that is shared between multiple planes; and
controlling a transmission of packets between the plurality of communication nodes based on the segmented forwarding table.

18. The method of claim 17, wherein the first range of addresses is used for high bandwidth traffic, and wherein the first range of addresses comprises addresses in a local forwarding table.

19. The method of claim 17, wherein the second range of addresses comprises addresses from a plurality of shared forwarding tables.

20. The method of claim 17, wherein the switch comprises optical communication components, and wherein the packets are transmitted across the switch using an optical signal.
